(19) United States
(12) Patent Application Publication
(10) Pub. No.: US 2021/0312334 A1
(43) Pub. Date: Oct. 7, 2021

(54) MODEL PARAMETER TRAINING METHOD, APPARATUS, AND DEVICE BASED ON FEDERATION LEARNING, AND MEDIUM

(71) Applicant: WEBANK CO., LTD, Shenzhen (CN)

(72) Inventors: Yang LIU, Shenzhen (CN); Tianjian CHEN, Shenzhen (CN); Qiang YANG, Shenzhen (CN)

(21) Appl. No.: 17/349,175

(22) Filed: Jun. 16, 2021

Related U.S. Application Data
(63) Continuation of application No. PCT/CN2019/119227, filed on Nov. 18, 2019.

(30) Foreign Application Priority Data
Mar. 1, 2019 (CN) 201910158538.8

(51) Int. Cl. G06N 20/00; H04L 9/00; H04L 9/30

(52) U.S. Cl. CPC G06N 20/00; H04L 9/30; H04L 9/008

(57) ABSTRACT

Disclosed are a model parameter training method, apparatus and device based on federation learning, and a medium. The method includes: when a first terminal receives encrypted second data sent by a second terminal, obtaining a loss encryption value and a first gradient encryption value; randomly generating a random vector with same dimension as the first gradient encryption value, blurring the first gradient encryption value based on the random vector, and sending the blurred first gradient encryption value and loss encryption value to the second terminal; when receiving a decrypted first gradient value and loss value returned by the second terminal, detecting whether a model to be trained is convergent according to the decrypted loss value; if yes, obtaining a second gradient value according to the random vector and the decrypted first gradient value and determining a sample parameter corresponding to the second gradient value as a model parameter.

### CROSS-REFERENCE TO RELATED APPLICATIONS

This application is a Continuation Application of International Application No. PCT/CN2019/119227, filed on Nov. 18, 2019, which claims priority to Chinese Application No. 201910158538.8, filed on Mar. 1, 2019, filed with Chinese National Intellectual Property Administration, and entitled “MODEL PARAMETER TRAINING METHOD, APPARATUS, AND DEVICE BASED ON FEDERATION LEARNING, AND MEDIUM”, the entire disclosure of which is incorporated herein by reference.

### TECHNICAL FIELD

The present disclosure relates to the technical field of data processing, and in particular to a model parameter training method, apparatus, and device based on federation learning, and a medium.

### BACKGROUND

“Machine learning” is one of the core research areas of artificial intelligence, and how to continue machine learning on the premise of protecting data privacy and meeting legal compliance requirements is a trend in the field of machine learning. In this context, people researched and put forward the concept of “federation learning”.

Federation learning uses technical algorithms to encrypt the model. Both parties of the federation can also perform model training to obtain model parameters without providing their own data. Federation learning protects user data privacy through parameter exchange under the encryption mechanism. The data and the model itself will not be transmitted, and the data of the other party cannot be guessed. Therefore, there is no possibility of data leakage, nor does it violate more stringent data protection laws such as General Data Protection Regulation (GDPR), which can maintain data integrity at a high level while ensuring data privacy. However, the current federation learning technology must rely on a trusted third party to model the data of the federation parties through the third party, which makes the application of federation learning limited in some scenarios.

### SUMMARY

The main objective of the present disclosure is to provide a model parameter training method, apparatus, and device based on federation learning, and a storage medium, which aims to realize that model training can be carried out without a trusted third party and only using data from both federation parties to avoid application restrictions.

In order to achieve the above objective, the present disclosure provides a model parameter training method based on federation learning, including the following operations:

when a first terminal receives encrypted second data sent by a second terminal, obtaining a loss encryption value and a first gradient encryption value according to the encrypted second data;

randomly generating a random vector with same dimension as the first gradient encryption value, blurring the first gradient encryption value based on the random vector, and sending the blurred first gradient encryption value and the loss encryption value to the second terminal;

when receiving a decrypted first gradient value and a decrypted loss value returned by the second terminal based on the blurred first gradient encryption value and the loss encryption value, detecting whether a model to be trained is in a convergent state according to the decrypted loss value; and

if the model to be trained is in the convergent state, obtaining a second gradient value according to the random vector and the decrypted first gradient value and determining a sample parameter corresponding to the second gradient value as a model parameter of the model to be trained.

Besides, in order to achieve the above objective, the present disclosure further provides a model parameter training apparatus based on federation learning, including:

a data acquisition module configured to, when a first terminal receives encrypted second data sent by a second terminal, obtain a loss encryption value and a first gradient encryption value according to the encrypted second data;

a first sending module configured to randomly generate a random vector with same dimension as the first gradient encryption value, blur the first gradient encryption value based on the random vector, and send the blurred first gradient encryption value and the loss encryption value to the second terminal;

a model detection module configured to, when receiving a decrypted first gradient value and a decrypted loss value returned by the second terminal based on the blurred first gradient encryption value and the loss encryption value, detect whether a model to be trained is in a convergent state according to the decrypted loss value; and

a parameter determination module configured to, if the model to be trained is in the convergent state, obtain a second gradient value according to the random vector and the decrypted first gradient value and determine a sample parameter corresponding to the second gradient value as a model parameter of the model to be trained.

In addition, in order to achieve the above objective, the present disclosure further provides a model parameter training device based on federation learning, including: a memory, a processor, and a model parameter training program based on federation learning stored on the memory and executable on the processor, the model parameter training program based on federation learning, when executed by the processor, implements operations of the model parameter training method based on federation learning as described above.

In addition, in order to achieve the above objective, the present disclosure further provides a storage medium. A model parameter training program based on federation learning is stored on the storage medium, and the model parameter training program based on federation learning, when executed by a processor, implements operations of the model parameter training method based on federation learning as described above.

The present disclosure provides a model parameter training method, apparatus, and device based on federation learning, and a medium. The method includes: when a first terminal receives encrypted second data sent by a second terminal, obtaining a loss encryption value and a first gradient encryption value according to the encrypted second data; randomly generating a random vector with same dimension as the first gradient encryption value, blurring the first gradient encryption value based on the random vector, and sending the blurred first gradient encryption value and the loss encryption value to the second terminal; when receiving a decrypted first gradient value and a decrypted loss value returned by the second terminal based on the blurred first gradient encryption value and the loss encryption value, detecting whether a model to be trained is in a convergent state according to the decrypted loss value; and if the model to be trained is in the convergent state, obtaining a second gradient value according to the random vector and the decrypted first gradient value, that is, removing the random vector in the decrypted first gradient value to restore the true gradient value to obtain the second gradient value and determining a sample parameter corresponding to the second gradient value as a model parameter of the model to be trained. The present disclosure only uses the data transmission and calculation between the first terminal and the second terminal to finally obtain the loss value, to determine the model parameter in the model to be trained. Thus, the model can be trained without relying on a third party and only using data from two parties to avoid application restrictions. Meanwhile, the second data received by the first terminal in the present disclosure is the encryption data of the intermediate result of the model. The data during the communication between the first terminal and the second terminal is encrypted and obfuscated. Therefore, the present disclosure will not disclose the original feature data, and can achieve the same level of security assurance, ensuring the privacy and security of terminal sample data.

### BRIEF DESCRIPTION OF THE DRAWINGS

FIG. 1 is a schematic structural diagram of a device of hardware operating environment according to an embodiment of the present disclosure.

FIG. 2 is a schematic flowchart of a model parameter training method based on federation learning according to a first embodiment of the present disclosure.

FIG. 3 is a schematic detailed flowchart of operation S30 in the first embodiment of the present disclosure.

FIG. 4 is a schematic detailed flowchart of operation S10 in the first embodiment of the present disclosure.

FIG. 5 is a schematic flowchart of the model parameter training method based on federation learning according to a second embodiment of the present disclosure.

FIG. 6 is a schematic flowchart of the model parameter training method based on federated learning according to a third embodiment of the present disclosure.

FIG. 7 is a schematic flowchart of the model parameter training method based on federated learning according to a fourth embodiment of the present disclosure.

FIG. 8 is a schematic diagram of functional modules of a model parameter training apparatus based on federation learning according to a first embodiment of the present disclosure.

The realization of the objective, functional characteristics, and advantages of the present disclosure are further described with reference to the accompanying drawings.

### DETAILED DESCRIPTION OF THE EMBODIMENTS

It should be understood that the specific embodiments described here are only used to explain the present application, and are not used to limit the present application.

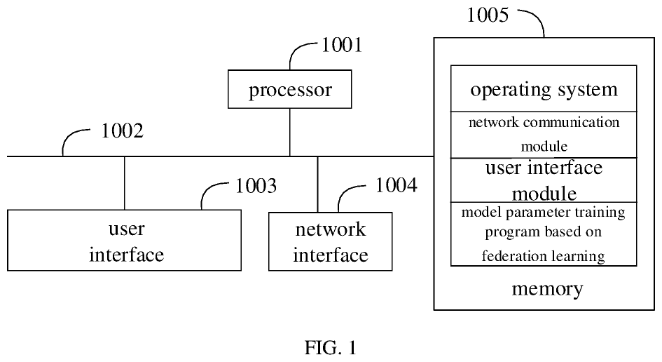

As shown in FIG. 1, FIG. 1 is a schematic structural diagram of a device of hardware operating environment according to an embodiment of the present disclosure.

In an embodiment of the present disclosure, a model parameter training device based on federation learning can be a terminal device such as a smart phone, a personal computer, a tablet, a portable computer, and a server.

As shown in FIG. 1, the model parameter training device based on federation learning may include a processor 1001, such as a CPU, a communication bus 1002, a user interface 1003, a network interface 1004, and a memory 1005. The communication bus 1002 is configured to implement communication between those components. The user interface 1003 may include a display, an input unit such as a keyboard. The user interface 1003 may also include a standard wired interface and a wireless interface. The network interface 1004 may further include a standard wired interface and a wireless interface (such as a WI-FI interface). The memory 1005 may be a high-speed random access memory (RAM) or a non-volatile memory, such as a magnetic disk memory. The memory 1005 may also be a storage device independent of the foregoing processor 1001.

Those skilled in the art should understand that the structure of the model parameter training device based on federation learning shown in FIG. 1 does not constitute a limitation on the model parameter training device based on federation learning, which may include more or fewer components, a combination of some components, or differently arranged components than shown in the figure.

As shown in FIG. 1, the memory 1005 as a computer storage medium may include an operating system, a network communication module, a user interface module, and a model parameter training program based on federation learning.

In the terminal shown in FIG. 1, the network interface 1004 is mainly configured to connect to a background server and perform data communication with the background server. The user interface 1003 is mainly configured to connect to a client and perform data communication with the client. The processor 1001 may be configured to call the model parameter training program based on federation learning stored in the memory 1005, and perform the following operations of the model parameter training method based on federation learning.

Based on the above hardware structure, various embodiments of the model parameter training method based on federation learning in the present disclosure are proposed.

The present disclosure provides a model parameter training method based on federation learning.

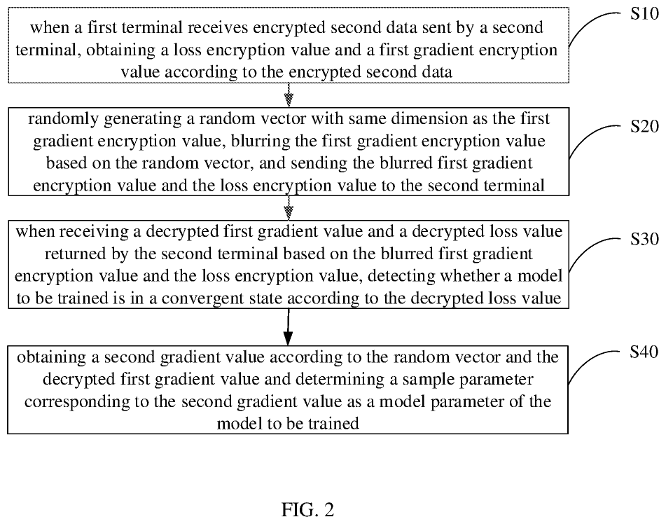

As shown in FIG. 2, FIG. 2 is a schematic flowchart of a model parameter training method based on federation learning according to a first embodiment of the present disclosure.

In this embodiment, the model parameter training method based on federation learning includes:

Operation S10, when a first terminal receives encrypted second data sent by a second terminal, obtaining a loss encryption value and a first gradient encryption value according to the encrypted second data.

In this embodiment, when receiving the encrypted second data sent by the second terminal, the first terminal obtains the loss encryption value and the first gradient encryption value according to the encrypted second data. The first terminal and the second terminal can be terminal devices such as smart phones, personal computers, tablet computers, portable computers, and servers. The second data is calculated by the second terminal based on its sample data and corresponding sample parameters, and is the intermediate result of the model. Then the second terminal encrypts the second data, and can generate a public key and a private key through the key pair generation software. Then, the generated public key is used to encrypt the second data through a homomorphic encryption algorithm to obtain the encrypted second data, so as to ensure the privacy and security of the transmitted data. Besides, the method for obtaining the loss encryption value and the first gradient encryption value is: when the first terminal receives the second data sent by the second terminal, obtaining first data corresponding to the second data and a sample label corresponding to the first data; calculating a loss value based on the first data, the encrypted second data, the sample label, and a preset loss function, and using a public key of the second terminal (the second terminal will send its public key to the first terminal), encrypting a calculation factor for calculating each loss value through a homomorphic encryption algorithm to obtain the encrypted loss value, which is the loss encryption value; and obtaining a gradient function according to the preset loss function, calculating the first gradient value according to the gradient function, and using the public key of the second terminal to encrypt the first gradient value through the homomorphic encryption algorithm to obtain the encrypted first gradient value, which is the first gradient encryption value. For the specific acquisition process, refer to the following embodiments, which will not be repeated here.

Operation S20, randomly generating a random vector with same dimension as the first gradient encryption value, blurring the first gradient encryption value based on the random vector, and sending the blurred first gradient encryption value and the loss encryption value to the second terminal.

After obtaining the loss encryption value and the first gradient encryption value, the first terminal randomly generates a random vector with the same dimension as the first gradient encryption value, and blurs the first gradient encryption value based on the random vector, that is, if the first gradient encryption value is [[g]], the random vector is R, then the first gradient encryption value after blurring is [[g+R]], and then the first gradient encryption value after blurring and the loss encryption value are sent to the second terminal. Correspondingly, when the second terminal receives the first gradient encryption value and the loss encryption value, the first gradient encryption value and the loss encryption value are decrypted by the private key of the second terminal to obtain the decrypted first gradient value and the loss value.

Operation S30, when receiving a decrypted first gradient value and a decrypted loss value returned by the second terminal based on the blurred first gradient encryption value and the loss encryption value, detecting whether a model to be trained is in a convergent state according to the decrypted loss value.

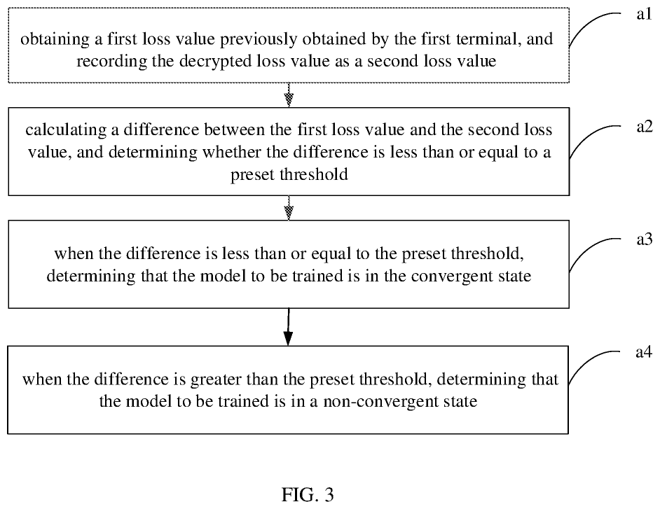

When receiving the decrypted first gradient value and the decrypted loss value returned by the second terminal based on the blurred first gradient encryption value and the loss encryption value, the first terminal detects whether the model to be trained is in the convergent state according to the decrypted loss value. Specially, as shown in FIG. 3, the operation of detecting whether a model to be trained is in a convergent state according to the decrypted loss value includes:

Operation a1, obtaining a first loss value previously obtained by the first terminal, and recording the decrypted loss value as a second loss value.

After obtaining the decrypted loss value, the first terminal obtains the first loss value previously obtained by the first terminal, and records the decrypted loss value as the second loss value. It should be noted that when the model to be trained is in a non-convergent state, the first terminal will continue to obtain the loss encryption value according to the encrypted second data sent by the second terminal, and then send the loss encryption value to the second terminal for decryption, then, receives the decrypted loss value returned by the second terminal until the model to be trained is in a convergent state. The first loss value is also the loss value after decryption by the second terminal. It can be understood that the first loss value is the decrypted loss value sent by the second terminal last time, and the second loss value is the decrypted loss value currently sent by the second terminal.

Operation a2, calculating a difference between the first loss value and the second loss value, and determining whether the difference is less than or equal to a preset threshold.

After obtaining the first loss value and the second loss value, the first terminal calculates the difference between the first loss value and the second loss value, and determines whether the difference is less than or equal to the preset threshold. The specific value of the preset threshold can be set in advance according to specific needs, and there is no specific limitation on the value corresponding to the preset threshold in this embodiment.

Operation a3, when the difference is less than or equal to the preset threshold, determining that the model to be trained is in the convergent state.

Operation a4, when the difference is greater than the preset threshold, determining that the model to be trained is in a non-convergent state.

When the difference is less than or equal to the preset threshold, the first terminal determines that the model to be trained is in the convergent state; when the difference is greater than the preset threshold, the first terminal determines that the model to be trained is in the non-convergent state.

Operation S40, if the model to be trained is in the convergent state, obtaining a second gradient value according to the random vector and the decrypted first gradient value and determining a sample parameter corresponding to the second gradient value as a model parameter of the model to be trained.

If it is detected that the model to be trained is in the convergent state, the first terminal obtains the second gradient value according to the random vector and the decrypted first gradient value, that is, the random vector in the decrypted first gradient value is removed to restore the true gradient value to obtain the second gradient value, and then the sample parameter corresponding to the second gradient value is determined as the model parameter of the model to be trained.

The present disclosure provides a model parameter training method based on federation learning. The method includes: when a first terminal receives encrypted second data sent by a second terminal, obtaining a loss encryption value and a first gradient encryption value according to the encrypted second data; randomly generating a random vector with same dimension as the first gradient encryption value, blurring the first gradient encryption value based on the random vector, and sending the blurred first gradient encryption value and the loss encryption value to the second terminal; when receiving a decrypted first gradient value and a decrypted loss value returned by the second terminal based on the blurred first gradient encryption value and the loss encryption value, detecting whether a model to be trained is in a convergent state according to the decrypted loss value; and if the model to be trained is in the convergent state, obtaining a second gradient value according to the random vector and the decrypted first gradient value and determining a sample parameter corresponding to the second gradient value as a model parameter of the model to be trained. The present disclosure only uses the data transmission and calculation between the first terminal and the second terminal to finally obtain the loss value, to determine the model parameter in the model to be trained. Thus, the model can be trained without relying on a third party and only using data from two parties to avoid application restrictions. Meanwhile, the second data received by the first terminal in the present disclosure is the encryption data of the intermediate result of the model. The data during the communication between the first terminal and the second terminal is encrypted and obfuscated. Therefore, the present disclosure will not disclose the original feature data, and can achieve the same level of security assurance, ensuring the privacy and security of terminal sample data.

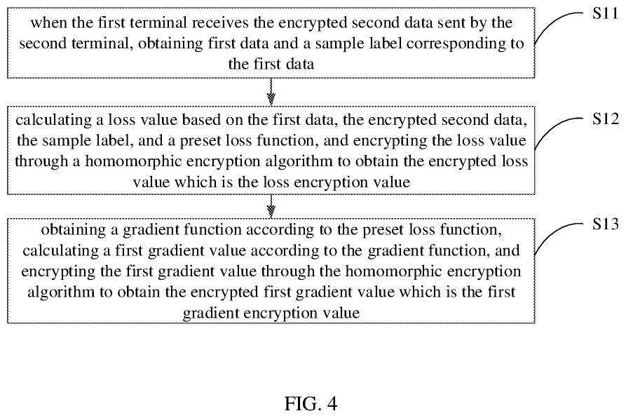

Further, as shown in FIG. 4, FIG. 4 is a schematic detailed flowchart of operation S10 in the first embodiment of the present disclosure.

Specially, operation S10 includes:

Operation S11, when the first terminal receives the encrypted second data sent by the second terminal, obtaining first data and a sample label corresponding to the first data.

In this embodiment, after receiving the second data sent by the second terminal, the first terminal obtains the corresponding first data and the sample label corresponding to the first data. The first data and the second data are the intermediate results of the model. The first data is calculated by the first terminal based on its sample data and corresponding sample parameter, and the second data is calculated by the second terminal based on its sample data and corresponding sample parameter. Specifically, the second data may be a sum of the product of the sample parameter in the second terminal and a variable value corresponding to the feature variable in the intersection of the sample data of the second terminal, and a square of the sum of the product. The calculation formula corresponding to the original second data can be: u_{A}=w_{A}^{T}x_{A}=w₁xᵢ₁+w₂xᵢ₂ . . . wₙxᵢₙ. The square of the sum of products is expressed as: u_{A}². w₁, w₂ . . . wₙ represents the sample parameter corresponding to the second terminal. The number of variable values corresponding to the feature variable in the second terminal is equal to the number of sample parameters corresponding to the second terminal, that is, a variable value corresponds to a sample parameter, x represents the feature value of the feature variable, 1, 2 . . . n represents the corresponding variable value and the number of sample parameters. For example, when there are three variable values for each feature variable in the intersection of the sample data of the second terminal, then u_{A}=w_{A}^{T}x_{A}=w₁xᵢ₁+w₂xᵢ₂+w₃xᵢ₃. It should be noted that the second data sent by the second terminal to the first terminal is encrypted second data. After calculating the second data, the second terminal uses the public key of the second terminal to encrypt the second data through the homomorphic encryption algorithm to obtain the encrypted second data, and sends the encrypted first data to the second terminal. The second data sent to the first terminal, that is, the encrypted second data can be expressed as [[u_{A}]] and [[u_{A}²]].

The process of calculating the first data by the first terminal is similar to the process of calculating the second data by the second terminal. For example, the formula for calculating the sum of the product of the variable value corresponding to the feature variable in the intersection of the sample parameter in the first terminal and the sample data of the first terminal is: u_{B}=w_{B}^{T}x_{B}=w₁xᵢ₁+w₂xᵢ₂ . . . wₙxᵢₙ. w₁, w₂ . . . wₙ represents the sample parameter corresponding to the feature value of each feature variable of the sample data in the first terminal.

Operation S12, calculating a loss value based on the first data, the encrypted second data, the sample label, and a preset loss function, and encrypting the loss value through a homomorphic encryption algorithm to obtain the encrypted loss value, which is the loss encryption value.

After receiving the encrypted second data and obtaining the corresponding first data and the corresponding sample label, the first terminal calculates the loss value based on the first data, the encrypted second data, the sample label, and the preset loss function, and encrypts the loss value through the homomorphic encryption algorithm to obtain the encrypted loss value, which is the loss encryption value.

Specially, the loss value is represented as loss.

$$loss = log 2 - \frac{1}{2} {yw}^{T} x + \frac{1}{8} {( {w}^{T} x )}^{2} .$$

u=w^{T}x=w_{A}^{T}x_{A}+w_{B}^{T}x_{B}, (w^{T}x)²=u²=(u_{A}+u_{B})²=u_{A}²+u_{B}²+2u_{A}u_{B}. y represents the label value of the sample label corresponding to the first data, and the value of the label value corresponding to the sample label can be set according to specific needs. In this embodiment, “0” and “1” may be used to represent the label values corresponding to different sample labels. When the first terminal calculates the loss value, the first terminal uses the public key of the second terminal (the second terminal will send its public key to the first terminal), and encrypts the calculation factor for calculating each loss value through the homomorphic encryption algorithm to obtain the encrypted loss value. The encrypted loss value (that is, the loss encryption value) is denoted as [[loss]]. log 2, yw^{T}x and (w^{T}x)² are the calculation factors for calculating the loss value.

$$[ [ loss ] ] = [ [ log 2 ] ] + ( - \frac{1}{2} ) * [ [ {yw}^{T} x ] ] + \frac{1}{8} [ [ {( {w}^{T} x )}^{2} ] ] .$$

[[u]]=[[u_{A}+u_{B}]]=[[u_{A}]]+[[u_{B}]]. └└(w^{T}x)²┘┘=[[(u)²]]+[[u_{A}²]]+[[u_{B}²]]+[[2u_{A}u_{B}]]=[[u_{A}²]]+[[u_{B}²]]+2u_{B}[[u_{A}]].

Operation S13, obtaining a gradient function according to the preset loss function, calculating a first gradient value according to the gradient function, and encrypting the first gradient value through the homomorphic encryption algorithm to obtain the encrypted first gradient value, which is the first gradient encryption value.

Then, the gradient function is obtained according to the preset loss function, the first gradient value is calculated according to the gradient function, and the first gradient value is encrypted through the homomorphic encryption algorithm to obtain the encrypted first gradient value, which is the first gradient encryption value.

Specially, the formula for the first terminal to calculate its corresponding gradient value (that is, the first gradient value) is:

$$g = \sum ( \frac{1}{2} y {w}^{T} x - 1 ) \frac{1}{2} yx .$$

After the first gradient value is calculated, the first terminal uses the public key of its second terminal to encrypt the first gradient value through the homomorphic encryption algorithm to obtain the encrypted loss value (i.e., the first gradient encryption value). Correspondingly, the formula of the first gradient encryption value is:

$$[ [ g ] ] = \sum [ [ d ] ] x . [ [ d ] ] = [ [ ( \frac{1}{2} y {w}^{T} x - 1 ) \frac{1}{2} y ] ] = ( \frac{1}{2} [ [ {yw}^{T} x ] ] + [ [ - 1 ] ] ) \frac{1}{2} y .$$

It should be noted that in this embodiment, parameter servers are used, both the first terminal and the second terminal have independent parameter servers for the aggregation and update synchronization of their respective sample data, while avoiding the leakage of their respective sample data. In addition, the sample parameters corresponding to the first terminal and the second terminal, that is, the model parameters are stored separately, which improves the security of the data of the first terminal and the second terminal.

In this embodiment, the loss value is calculated according to the received encrypted second data from the second terminal, the first data of the first terminal, and the sample label corresponding to the first data, and the homomorphic encryption algorithm is used to encrypt the loss value to obtain the loss encryption value, such that during the process of calculating the loss value, the first terminal cannot obtain the specific sample data of the second terminal, realizing that during the process of calculating model parameters by the first terminal in conjunction with the second terminal sample data, the loss value required to calculate the model parameters can be calculated on the basis of not exposing the sample data of the second terminal, which improves the privacy of the sample data of the second terminal during the process of calculating the model parameters.

Based on the foregoing embodiment, a second embodiment of the model parameter training method based on federation learning in the present disclosure is proposed.

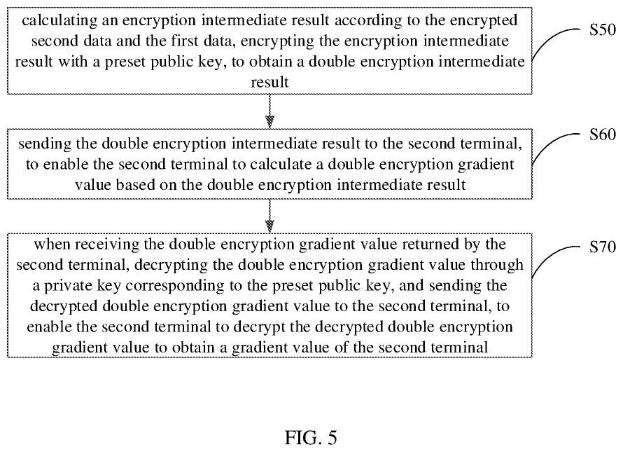

As shown in FIG. 5, in this embodiment, the model parameter training method based on federation learning further includes:

Operation S50, calculating an encryption intermediate result according to the encrypted second data and the first data, encrypting the encryption intermediate result with a preset public key, to obtain a double encryption intermediate result.

As one of the ways to obtain the gradient value of the second terminal, in this embodiment, the first terminal may calculate the encryption intermediate result according to the encrypted second data and the obtained first data, and then encrypt the encrypted intermediate result with the preset public key to obtain the double encryption intermediate result. The preset public key is a public key generated by the first terminal according to the key pair generation software, and is the public key of the first terminal.

Operation S60, sending the double encryption intermediate result to the second terminal, so that the second terminal calculates a double encryption gradient value based on the double encryption intermediate result.

Then, the double encryption intermediate result is sent to the second terminal, so that the second terminal calculates the double encryption gradient value based on the double encryption intermediate result, and the second terminal sends the double encryption gradient value to the first terminal.

Operation S70, when receiving the double encryption gradient value returned by the second terminal, decrypting the double encryption gradient value through a private key corresponding to the preset public key, and sending the decrypted double encryption gradient value to the second terminal, to enable the second terminal to decrypt the decrypted double encryption gradient value to obtain a gradient value of the second terminal.

When receiving the double encryption gradient value returned by the second terminal, the first terminal decrypts the double encryption gradient value once through a private key (i.e., the private key of the first terminal) corresponding to the preset public key, and sends the decrypted double encryption gradient value to the second terminal, such that the second terminal decrypts the decrypted double encryption gradient value twice through its private key (i.e., the private key of the second terminal) to obtain the gradient value of the second terminal. Thus, the second terminal may update the model parameter according to the gradient value of the second terminal.

In this embodiment, the first data and the second data communicated between the first terminal and the second terminal are all encrypted data of the intermediate result of the model, and there is no leakage of the original feature data. In addition, other data transmission processes are also encrypted, which can train the model parameter of the second terminal and determine the model parameter of the second terminal while ensuring the privacy and security of the terminal data.

Based on the foregoing embodiments, a third embodiment of the model parameter training method based on federation learning in the present disclosure is proposed.

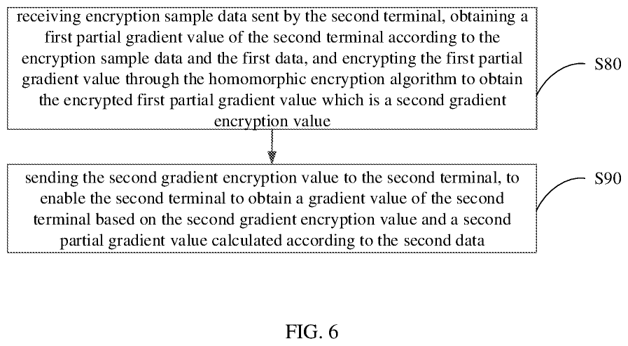

As shown in FIG. 6, in this embodiment, the model parameter training method based on federation learning further includes:

Operation 580, receiving encryption sample data sent by the second terminal, obtaining a first partial gradient value of the second terminal according to the encryption sample data and the first data, and encrypting the first partial gradient value through the homomorphic encryption algorithm to obtain the encrypted first partial gradient value, which is a second gradient encryption value.

As yet another way to obtain the gradient value of the second terminal, in this embodiment, the second terminal may send the encryption sample data to the first terminal, so that the first terminal calculates the partial gradient value of the second terminal according to the encryption sample data. Specifically, the first terminal receives the encryption sample data sent by the second terminal, and then obtains the first partial gradient value of the second terminal according to the encryption sample data and the first data obtained according to the encrypted second data, uses the public key of the second terminal to encrypt the first partial gradient value through a homomorphic encryption algorithm to obtain the encrypted first partial gradient value, which is the second gradient encrypted value.

Operation S90, sending the second gradient encryption value to the second terminal, to enable the second terminal to obtain a gradient value of the second terminal based on the second gradient encryption value and a second partial gradient value calculated according to the second data.

Then, the second gradient encryption value is sent to the second terminal, such that the second terminal obtains the gradient value of the second terminal based on the second gradient encryption value and the second partial gradient value calculated according to the second data. Specially, the second terminal calculates the second partial gradient value according to the second data, and decrypts the received second gradient encrypted value to obtain the first partial gradient value. Then, the first partial gradient value and the second partial gradient value are combined to obtain the gradient value of the second terminal, and the second terminal can update the model parameters according to the gradient value of the second terminal.

In this embodiment, the first terminal obtains a part of the gradient of the second terminal (that is, the first partial gradient value) through the received encryption sample data sent by the second terminal, then sends the encrypted first partial gradient value (that is, the second gradient encryption value) to the second terminal, such that after decryption by the second terminal, the first partial gradient value is obtained, thereby the first partial gradient value and the second partial gradient value (calculated locally by the second terminal) are further combined to obtain the gradient value of the second terminal, and the model parameters are updated according to the gradient value of the second terminal. In the above manner, this embodiment trains the model parameter of the second terminal to determine the model parameter of the second terminal, and since the data communicated by the first terminal and the second terminal are both encrypted, the privacy and security of the terminal data can be guaranteed.

Besides, it should be noted that, as another way of obtaining the gradient value of the second terminal, the same method as in the first embodiment may be used to calculate the gradient value of the second terminal. Specially, the first terminal sends the encrypted first data to the second terminal. When the second terminal receives the encrypted first data sent by the first terminal, obtaining the loss encryption value and the gradient encryption value of the second terminal according to the encrypted first data; randomly generating a random vector with same dimension as the gradient encryption value of the second terminal, blurring the gradient encryption value of the second terminal based on the random vector, and sending the blurred gradient encryption value of the second terminal and the loss encryption value of the second terminal to the first terminal; when receiving a decrypted gradient value and a decrypted loss value of the second terminal returned by the first terminal based on the blurred gradient encryption value of the second terminal and the loss encryption value of the second terminal, detecting whether a model to be trained is in a convergent state according to the decrypted loss value of the second terminal; and if the model to be trained is in the convergent state, obtaining a gradient value of the second terminal according to the random vector and the decrypted gradient value of the second terminal, that is, remove the random vector in the decrypted gradient value of the second terminal to restore the true gradient value to obtain the gradient value of the second terminal, and then determining a sample parameter corresponding to the gradient value of the second terminal as a model parameter of the model to be trained. This process is basically similar to that in the above-mentioned first embodiment, and reference may be made to the above-mentioned first embodiment, which will not be repeated here.

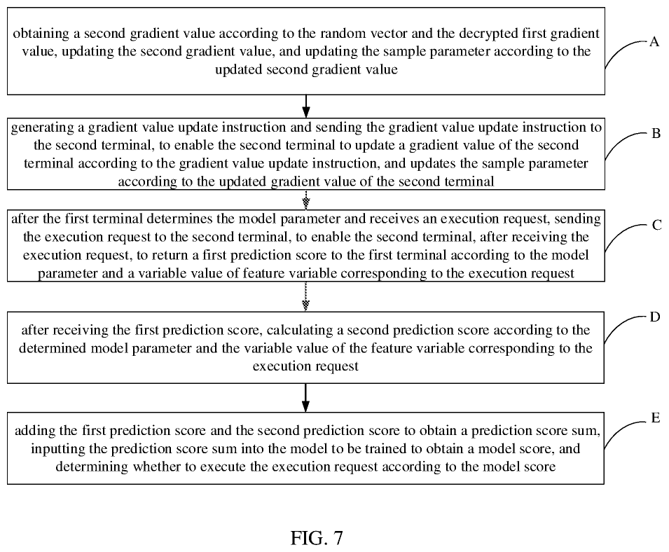

Further, based on the above embodiments, a fourth embodiment of the model parameter training method based on federation learning in the present disclosure is proposed. In this embodiment, after the operation S30, as shown in FIG. 7, the model parameter training method based on federation learning further includes:

If the model to be trained is in a non-convergent state, then performing operation A: obtaining a second gradient value according to the random vector and the decrypted first gradient value, updating the second gradient value, and updating the sample parameter according to the updated second gradient value.

In this embodiment, if the model to be trained is in a non-convergent state, that is, when the difference is greater than the preset threshold, the first terminal obtains the second gradient value according to the random vector and the decrypted first gradient value, that is, removes the random vector in the decrypted first gradient value to restore the true gradient value, to obtain the second gradient value, and then updates the second gradient value, and correspondingly updates the sample parameter according to the updated second gradient value.

The method for updating the sample parameter is: calculating the product of the updated second gradient value and the preset coefficient, and subtracting the product from the sample parameter to obtain the updated sample parameter. Specifically, the formula used by the first terminal to update its corresponding sample parameter according to the updated gradient value is: w=w₀−ηg. w represents the sample parameter after the update, and w₀ represents the sample parameter before the update; η is a coefficient, which is preset, that is, η is a preset coefficient, and its corresponding value can be set according to specific needs; g is the updated gradient value.

Operation B: generating a gradient value update instruction and sending the gradient value update instruction to the second terminal, to enable the second terminal to update a gradient value of the second terminal according to the gradient value update instruction, and updates the sample parameter according to the updated gradient value of the second terminal.

The first terminal generates a corresponding gradient value update instruction and sends the instruction to the second terminal, such that the second terminal updates the gradient value of the second terminal according to the gradient value update instruction, and updates the corresponding sample parameter according to the updated gradient value of the second terminal. The update method of the sample parameter of the second terminal is basically the same as the update method of the gradient value of the first terminal, and will not be repeated here.

It should be noted that the execution of operation B and operation A has no particular order.

Further, based on the above embodiments, a fifth embodiment of the model parameter training method based on federation learning in the present disclosure is proposed. in this embodiment, after the operation S30, the model parameter training method based on federation learning further includes:

Operation C, after the first terminal determines the model parameter and receives an execution request, sending the execution request to the second terminal, to enable the second terminal, after receiving the execution request, to return a first prediction score to the first terminal according to the model parameter and a variable value of feature variable corresponding to the execution request.

In this embodiment, after the first terminal determines the model parameters, the first terminal detects whether the execution request is received. After the first terminal receives the execution request, the first terminal sends the execution request to the second terminal. After the second terminal receives the execution request, the second terminal obtains its corresponding model parameter and obtains the variable value of the feature variable corresponding to the execution request. The first prediction score is calculated according to the model parameter and the variable value, and the first prediction score is sent to the first terminal. It is understandable that the formula for the first terminal to calculate the first prediction score is w_{A}^{T}x_{A}=w₁xᵢ₁+w₂xᵢ₂ . . . wₙxᵢₙ.

Operation D, after receiving the first prediction score, calculating a second prediction score according to the determined model parameter and the variable value of the feature variable corresponding to the execution request.

After the first terminal receives the first prediction score sent by the second terminal, the first terminal calculates the second prediction score according to the determined model parameter and the variable value of the feature variable corresponding to the execution request. The formula for the first terminal to calculate the second prediction score is: w_{B}^{T}x_{B}=w₁xᵢ₁+w₂xᵢ₂ . . . wₙxᵢₙ.

Operation E, adding the first prediction score and the second prediction score to obtain a prediction score sum, inputting the prediction score sum into the model to be trained to obtain a model score, and determining whether to execute the execution request according to the model score.

When the first terminal obtains the first prediction score and the second prediction score, the first terminal adds the first prediction score and the second prediction score to obtain the sum of the prediction scores, and inputs the sum of the prediction score into the model to be trained to obtain the model score. The expression for predicting the sum of scores is: w^{T}x=w_{A}^{T}x_{A}+w_{B}^{T}x_{B}. The expression of the model to be trained is: P(y=1|x)=1/1+exp(−w^{T}x).

After obtaining the model score, the first terminal can determine whether to execute the execution request according to the model score. For example, when the model to be trained is a fraud model and the execution request is a loan request, if the calculated model score is greater than or equal to the preset score, the first terminal determines that the loan request is a fraud request and refuses to execute the loan request; if the calculated model score is less than the preset score, the first terminal determines that the loan request is a real loan request, and executes the loan request.

In this embodiment, after receiving the execution request through the first terminal, the execution request is analyzed through the model to be trained to determine whether to execute the execution request, which improves the security during the process of executing the request by the first terminal.

The present disclosure further provides a model parameter training apparatus based on federation learning.

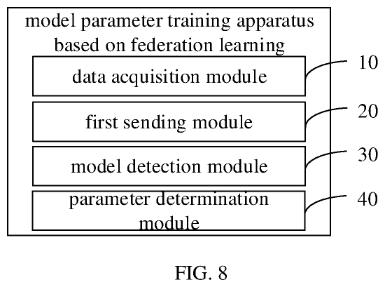

As shown in FIG. 8, FIG. 8 is a schematic diagram of functional modules of a model parameter training apparatus based on federation learning according to a first embodiment of the present disclosure.

The model parameter training apparatus based on federation learning includes:

a data acquisition module 10 configured to, when a first terminal receives encrypted second data sent by a second terminal, obtain a loss encryption value and a first gradient encryption value according to the encrypted second data;

a first sending module 20 configured to randomly generate a random vector with same dimension as the first gradient encryption value, blur the first gradient encryption value based on the random vector, and send the blurred first gradient encryption value and the loss encryption value to the second terminal;

a model detection module 30 configured to, when receiving a decrypted first gradient value and a decrypted loss value returned by the second terminal based on the blurred first gradient encryption value and the loss encryption value, detect whether a model to be trained is in a convergent state according to the decrypted loss value; and

a parameter determination module 40 configured to, if the model to be trained is in the convergent state, obtain a second gradient value according to the random vector and the decrypted first gradient value and determine a sample parameter corresponding to the second gradient value as a model parameter of the model to be trained.

Further, the data acquisition module 10 includes:

a first acquisition unit configured to, when the first terminal receives the encrypted second data sent by the second terminal, obtain first data and a sample label corresponding to the first data;

a first encryption unit configured to calculate a loss value based on the first data, the encrypted second data, the sample label, and a preset loss function, and encrypt the loss value through a homomorphic encryption algorithm to obtain the encrypted loss value, which is the loss encryption value; and

a second encryption unit configured to obtain a gradient function according to the preset loss function, calculate a first gradient value according to the gradient function, and encrypt the first gradient value through the homomorphic encryption algorithm to obtain the encrypted first gradient value, which is the first gradient encryption value.

Further, the model parameter training apparatus based on federation learning further includes:

a first encryption module configured to calculate an encryption intermediate result according to the encrypted second data and the first data, encrypt the encryption intermediate result with a preset public key, to obtain a double encryption intermediate result;

a first calculation module configured to send the double encryption intermediate result to the second terminal, so that the second terminal calculates a double encryption gradient value based on the double encryption intermediate result; and

a second decryption module configured to, when receiving the double encryption gradient value returned by the second terminal, decrypt the double encryption gradient value through a private key corresponding to the preset public key, and send the decrypted double encryption gradient value to the second terminal, to enable the second terminal to decrypt the decrypted double encryption gradient value to obtain a gradient value of the second terminal.

Further, the model parameter training apparatus based on federation learning further includes:

a second encryption module configured to receive encryption sample data sent by the second terminal, obtain a first partial gradient value of the second terminal according to the encryption sample data and the first data, and encrypt the first partial gradient value through the homomorphic encryption algorithm to obtain the encrypted first partial gradient value, which is a second gradient encryption value; and

a second sending module configured to send the second gradient encryption value to the second terminal, to enable the second terminal to obtain a gradient value of the second terminal based on the second gradient encryption value and a second partial gradient value calculated according to the second data.

Further, the model parameter training apparatus based on federation learning further includes:

a parameter updating module configured to, if the model to be trained is in a non-convergent state, obtain a second gradient value according to the random vector and the decrypted first gradient value, update the second gradient value, and update the sample parameter according to the updated second gradient value; and

an instruction sending module configured to generate a gradient value update instruction and send the gradient value update instruction to the second terminal, to enable the second terminal to update a gradient value of the second terminal according to the gradient value update instruction, and updates the sample parameter according to the updated gradient value of the second terminal.

Further, the model parameter training apparatus based on federation learning further includes:

a third sending module configured to, after the first terminal determines the model parameter and receives an execution request, send the execution request to the second terminal, to enable the second terminal, after receiving the execution request, to return a first prediction score to the first terminal according to the model parameter and a variable value of feature variable corresponding to the execution request;

a second calculation module configured to, after receiving the first prediction score, calculate a second prediction score according to the determined model parameter and the variable value of the feature variable corresponding to the execution request; and

a score acquisition module configured to add the first prediction score and the second prediction score to obtain a prediction score sum, input the prediction score sum into the model to be trained to obtain a model score, and determine whether to execute the execution request according to the model score.

Further, the model detection module 30 includes:

a second acquisition unit configured to obtain a first loss value previously obtained by the first terminal, and record the decrypted loss value as a second loss value;

a difference determination unit configured to calculate a difference between the first loss value and the second loss value, and determine whether the difference is less than or equal to a preset threshold;

a first determination unit configured to, when the difference is less than or equal to the preset threshold, determine that the model to be trained is in the convergent state; and

a second determination unit configured to, when the difference is greater than the preset threshold, determine that the model to be trained is in a non-convergent state.

The functions of each module in the above-mentioned model parameter training apparatus based on federation learning correspond to the operations in the embodiment of the above-mentioned model parameter training method based on federation learning, and their functions and implementation processes will not be repeated here.

The present disclosure further provides a storage medium. A model parameter training program based on federation learning is stored on the storage medium, and the model parameter training program based on federation learning, when executed by a processor, implements the operations of the model parameter training method based on federation learning of any one of the above embodiments.

The specific embodiments of the storage medium of the present disclosure are basically the same as the foregoing embodiments of the model parameter training method based on federation learning, and will not be repeated here.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element.

The serial numbers of the foregoing embodiments of the present disclosure are only for description, and do not represent the advantages and disadvantages of the embodiments.

Through the description of the above embodiment, those skilled in the art can clearly understand that the above-mentioned embodiments can be implemented by software plus a necessary general hardware platform, of course, it can also be implemented by hardware, but in many cases the former is a better implementation. Based on this understanding, the technical solution of the present disclosure can be embodied in the form of software product in essence or the part that contributes to the existing technology. The computer software product is stored on a storage medium (such as ROM/RAM, magnetic disk, optical disk) as described above, including several instructions to cause a terminal device (which can be a mobile phone, a computer, a server, an air conditioner, or a network device, etc.) to execute the method described in each embodiment of the present disclosure.

The above are only some embodiments of the present disclosure, and do not limit the scope of the present disclosure thereto. Under the inventive concept of the present disclosure, equivalent structural transformations made according to the description and drawings of the present disclosure, or direct/indirect application in other related technical fields are included in the scope of the present disclosure.

What is claimed is:

1. A model parameter training method based on federation learning, comprising the following operations:
when a first terminal receives encrypted second data sent by a second terminal, obtaining a loss encryption value and a first gradient encryption value according to the encrypted second data;
randomly generating a random vector with same dimension as the first gradient encryption value, blurring the first gradient encryption value based on the random vector, and sending the blurred first gradient encryption value and the loss encryption value to the second terminal;
when receiving a decrypted first gradient value and a decrypted loss value returned by the second terminal based on the blurred first gradient encryption value and the loss encryption value, detecting whether a model to be trained is in a convergent state according to the decrypted loss value; and
if the model to be trained is in the convergent state, obtaining a second gradient value according to the random vector and the decrypted first gradient value and determining a sample parameter corresponding to the second gradient value as a model parameter of the model to be trained.

2. The model parameter training method based on federation learning of claim 1, wherein the operation of when a first terminal receives encrypted second data sent by a second terminal, obtaining a loss encryption value and a first gradient encryption value according to the encrypted second data comprises:
when the first terminal receives the encrypted second data sent by the second terminal, obtaining first data and a sample label corresponding to the first data;
calculating a loss value based on the first data, the encrypted second data, the sample label, and a preset loss function, and encrypting the loss value through a homomorphic encryption algorithm to obtain the encrypted loss value which is the loss encryption value; and
obtaining a gradient function according to the preset loss function, calculating a first gradient value according to the gradient function, and encrypting the first gradient value through the homomorphic encryption algorithm to obtain the encrypted first gradient value which is the first gradient encryption value.

3. The model parameter training method based on federation learning of claim 2, further comprising:
calculating an encryption intermediate result according to the encrypted second data and the first data, encrypting the encryption intermediate result with a preset public key, to obtain a double encryption intermediate result;
sending the double encryption intermediate result to the second terminal, to enable the second terminal to calculate a double encryption gradient value based on the double encryption intermediate result; and
when receiving the double encryption gradient value returned by the second terminal, decrypting the double encryption gradient value through a private key corresponding to the preset public key, and sending the decrypted double encryption gradient value to the second terminal, to enable the second terminal to decrypt the decrypted double encryption gradient value to obtain a gradient value of the second terminal.

4. The model parameter training method based on federation learning of claim 2, further comprising:
receiving encryption sample data sent by the second terminal, obtaining a first partial gradient value of the second terminal according to the encryption sample data and the first data, and encrypting the first partial gradient value through the homomorphic encryption algorithm to obtain the encrypted first partial gradient value which is a second gradient encryption value; and
sending the second gradient encryption value to the second terminal, to enable the second terminal to obtain a gradient value of the second terminal based on the second gradient encryption value and a second partial gradient value calculated according to the second data.

5. The model parameter training method based on federation learning of claim 3, wherein after the operation of detecting whether a model to be trained is in a convergent state according to the decrypted loss value, the method further comprises:
if the model to be trained is in a non-convergent state, obtaining a second gradient value according to the random vector and the decrypted first gradient value, updating the second gradient value, and updating the sample parameter according to the updated second gradient value; and
generating a gradient value update instruction and sending the gradient value update instruction to the second terminal, to enable the second terminal to update a gradient value of the second terminal according to the gradient value update instruction, and update the sample parameter according to the updated gradient value of the second terminal.

6. The model parameter training method based on federation learning of claim 1, wherein after the operation of obtaining a second gradient value according to the random vector and the decrypted first gradient value and determining a sample parameter corresponding to the second gradient value as a model parameter of the model to be trained, the method further comprises:
after the first terminal determines the model parameter and receives an execution request, sending the execution request to the second terminal, to enable the second terminal, after receiving the execution request, to return a first prediction score to the first terminal according to the model parameter and a variable value of feature variable corresponding to the execution request;
after receiving the first prediction score, calculating a second prediction score according to the determined model parameter and the variable value of the feature variable corresponding to the execution request; and
adding the first prediction score and the second prediction score to obtain a prediction score sum, inputting the prediction score sum into the model to be trained to obtain a model score, and determining whether to execute the execution request according to the model score.

7. The model parameter training method based on federation learning of claim 1, wherein the operation of detecting whether a model to be trained is in a convergent state according to the decrypted loss value comprises:
obtaining a first loss value previously obtained by the first terminal, and recording the decrypted loss value as a second loss value;
calculating a difference between the first loss value and the second loss value, and determining whether the difference is less than or equal to a preset threshold;
when the difference is less than or equal to the preset threshold, determining that the model to be trained is in the convergent state; and
when the difference is greater than the preset threshold, determining that the model to be trained is in a non-convergent state.

8. A model parameter training device based on federation learning, comprising: a memory, a processor, and a model parameter training program based on federation learning stored on the memory and executable on the processor, the model parameter training program based on federation learning, when executed by the processor, implements the following operations:
when a first terminal receives encrypted second data sent by a second terminal, obtaining a loss encryption value and a first gradient encryption value according to the encrypted second data;
randomly generating a random vector with same dimension as the first gradient encryption value, blurring the first gradient encryption value based on the random vector, and sending the blurred first gradient encryption value and the loss encryption value to the second terminal;
when receiving a decrypted first gradient value and a decrypted loss value returned by the second terminal based on the blurred first gradient encryption value and the loss encryption value, detecting whether a model to be trained is in a convergent state according to the decrypted loss value; and
if the model to be trained is in the convergent state, obtaining a second gradient value according to the random vector and the decrypted first gradient value and determining a sample parameter corresponding to the second gradient value as a model parameter of the model to be trained.

9. The model parameter training device based on federation learning of claim 8, wherein the model parameter training program based on federation learning, when executed by the processor, further implements the following operations:
when the first terminal receives the encrypted second data sent by the second terminal, obtaining first data and a sample label corresponding to the first data;
calculating a loss value based on the first data, the encrypted second data, the sample label, and a preset loss function, and encrypting the loss value through a homomorphic encryption algorithm to obtain the encrypted loss value, which is the loss encryption value; and
obtaining a gradient function according to the preset loss function, calculating a first gradient value according to the gradient function, and encrypting the first gradient value through the homomorphic encryption algorithm to obtain the encrypted first gradient value, which is the first gradient encryption value.

10. The model parameter training device based on federation learning of claim 9, wherein the model parameter training program based on federation learning, when executed by the processor, further implements the following operations:
calculating an encryption intermediate result according to the encrypted second data and the first data, encrypting the encryption intermediate result with a preset public key, to obtain a double encryption intermediate result;
sending the double encryption intermediate result to the second terminal, so that the second terminal calculates a double encryption gradient value based on the double encryption intermediate result; and
when receiving the double encryption gradient value returned by the second terminal, decrypting the double encryption gradient value through a private key corresponding to the preset public key, and sending the decrypted double encryption gradient value to the second terminal, to enable the second terminal to decrypt the decrypted double encryption gradient value to obtain a gradient value of the second terminal.

11. The model parameter training device based on federation learning of claim 9, wherein the model parameter training program based on federation learning, when executed by the processor, further implements the following operations:
receiving encryption sample data sent by the second terminal, obtaining a first partial gradient value of the second terminal according to the encryption sample data and the first data, and encrypting the first partial gradient value through the homomorphic encryption algorithm to obtain the encrypted first partial gradient value which is a second gradient encryption value; and
sending the second gradient encryption value to the second terminal, to enable the second terminal to obtain a gradient value of the second terminal based on the second gradient encryption value and a second partial gradient value calculated according to the second data.

12. The model parameter training device based on federation learning of claim 10, wherein the model parameter training program based on federation learning, when executed by the processor, further implements the following operations:
if the model to be trained is in a non-convergent state, obtaining a second gradient value according to the random vector and the decrypted first gradient value, updating the second gradient value, and updating the sample parameter according to the updated second gradient value; and
generating a gradient value update instruction and sending the gradient value update instruction to the second terminal, to enable the second terminal to update a gradient value of the second terminal according to the gradient value update instruction, and update the sample parameter according to the updated gradient value of the second terminal.

13. The model parameter training device based on federation learning of claim 8, wherein the model parameter training program based on federation learning, when executed by the processor, further implements the following operations:
after the first terminal determines the model parameter and receives an execution request, sending the execution request to the second terminal, to enable the second terminal, after receiving the execution request, to return a first prediction score to the first terminal according to the model parameter and a variable value of feature variable corresponding to the execution request;
after receiving the first prediction score, calculating a second prediction score according to the determined model parameter and the variable value of the feature variable corresponding to the execution request; and
adding the first prediction score and the second prediction score to obtain a prediction score sum, inputting the prediction score sum into the model to be trained to obtain a model score, and determining whether to execute the execution request according to the model score.

14. The model parameter training device based on federation learning of claim 8, wherein the model parameter training program based on federation learning, when executed by the processor, further implements the following operations:
obtaining a first loss value previously obtained by the first terminal, and recording the decrypted loss value as a second loss value;
calculating a difference between the first loss value and the second loss value, and determining whether the difference is less than or equal to a preset threshold;
when the difference is less than or equal to the preset threshold, determining that the model to be trained is in the convergent state; and
when the difference is greater than the preset threshold, determining that the model to be trained is in a non-convergent state.

15. A non-transitory computer readable storage medium, wherein a model parameter training program based on federation learning is stored on the non-transitory computer readable storage medium, and the model parameter training program based on federation learning, when executed by a processor, implements the following operations:
when a first terminal receives encrypted second data sent by a second terminal, obtaining a loss encryption value and a first gradient encryption value according to the encrypted second data;
randomly generating a random vector with same dimension as the first gradient encryption value, blurring the first gradient encryption value based on the random vector, and sending the blurred first gradient encryption value and the loss encryption value to the second terminal;
when receiving a decrypted first gradient value and a decrypted loss value returned by the second terminal based on the blurred first gradient encryption value and the loss encryption value, detecting whether a model to be trained is in a convergent state according to the decrypted loss value; and
if the model to be trained is in the convergent state, obtaining a second gradient value according to the random vector and the decrypted first gradient value and determining a sample parameter corresponding to the second gradient value as a model parameter of the model to be trained.

16. The non-transitory computer readable storage medium of claim 15, wherein the model parameter training program based on federation learning, when executed by the processor, further implements the following operations:
when the first terminal receives the encrypted second data sent by the second terminal, obtaining first data and a sample label corresponding to the first data;
calculating a loss value based on the first data, the encrypted second data, the sample label, and a preset loss function, and encrypting the loss value through a homomorphic encryption algorithm to obtain the encrypted loss value, which is the loss encryption value; and
obtaining a gradient function according to the preset loss function, calculating a first gradient value according to the gradient function, and encrypting the first gradient value through the homomorphic encryption algorithm to obtain the encrypted first gradient value, which is the first gradient encryption value.

17. The non-transitory computer readable storage medium of claim 16, wherein the model parameter training program based on federation learning, when executed by the processor, further implements the following operations:
calculating an encryption intermediate result according to the encrypted second data and the first data, encrypting the encryption intermediate result with a preset public key, to obtain a double encryption intermediate result;
sending the double encryption intermediate result to the second terminal, so that the second terminal calculates a double encryption gradient value based on the double encryption intermediate result; and
when receiving the double encryption gradient value returned by the second terminal, decrypting the double encryption gradient value through a private key corresponding to the preset public key, and sending the decrypted double encryption gradient value to the second terminal, to enable the second terminal to decrypt the decrypted double encryption gradient value to obtain a gradient value of the second terminal.

18. The non-transitory computer readable storage medium of claim 16, wherein the model parameter training program based on federation learning, when executed by the processor, further implements the following operations:
receiving encryption sample data sent by the second terminal, obtaining a first partial gradient value of the second terminal according to the encryption sample data and the first data, and encrypting the first partial gradient value through the homomorphic encryption algorithm to obtain the encrypted first partial gradient value which is a second gradient encryption value; and
sending the second gradient encryption value to the second terminal, to enable the second terminal to obtain a gradient value of the second terminal based on the second gradient encryption value and a second partial gradient value calculated according to the second data.

19. The non-transitory computer readable storage medium of claim 17, wherein the model parameter training program based on federation learning, when executed by the processor, further implements the following operations:
if the model to be trained is in a non-convergent state, obtaining a second gradient value according to the random vector and the decrypted first gradient value, updating the second gradient value, and updating the sample parameter according to the updated second gradient value; and
generating a gradient value update instruction and sending the gradient value update instruction to the second terminal, to enable the second terminal to update a gradient value of the second terminal according to the gradient value update instruction, and update the sample parameter according to the updated gradient value of the second terminal.

20. The non-transitory computer readable storage medium of claim 15, wherein the model parameter training program based on federation learning, when executed by the processor, further implements the following operations:
after the first terminal determines the model parameter and receives an execution request, sending the execution request to the second terminal, to enable the second terminal, after receiving the execution request, to return a first prediction score to the first terminal according to the model parameter and a variable value of feature variable corresponding to the execution request;
after receiving the first prediction score, calculating a second prediction score according to the determined model parameter and the variable value of the feature variable corresponding to the execution request; and
adding the first prediction score and the second prediction score to obtain a prediction score sum, inputting the prediction score sum into the model to be trained to obtain a model score, and determining whether to execute the execution request according to the model score.
